(19) United States
(12) Patent Application Publication
(10) Pub. No.: US 2010/0075160 A1
(43) Pub. Date: Mar. 25, 2010

(54) Process for the Moderately Refractory Assembling of Articles Made of SiC-Based Materials by Non-Reactive Brazing, Brazing Compositions, and Joint and Assembly Obtained by this Process

(75) Inventors: Valerie CHAUMAT, Saint- Paul -de- Varces (FR); Jean-François Henne, Grenoble (FR)

Correspondence Address: MILES & STOCKBRIDGE PC, 1751 PINNACLE DRIVE, SUITE 500, MCLEAN, VA, 22102-3833, US

(73) Assignee: COMMISSARIAT A L'ENERGIE ATOMIQUE

(21) Appl. No.: 12/559,535

(22) Filed: Sep. 15, 2009

(30) Foreign Application Priority Data
Sep. 22, 2008 (FR) 08 56352

(51) Int. Cl. B32B 9/04; B23K 1/00; C22C 29/18

(52) U.S. Cl. 428/448; 228/121; 75/230

(57) ABSTRACT

Process for the assembly of at least two articles made of silicon carbide-based materials by moderately refractory non-reactive brazing, in which the articles are placed in contact with a non-reactive brazing composition, and the assembly formed by the articles and the brazing composition is heated to a brazing temperature that is sufficient to melt the brazing composition in order to form a refractory joint, in which the non-reactive brazing composition is a binary alloy formed, as mass percentages, from 56% to 70% silicon and 44% to 30% yttrium.

### TECHNICAL FIELD

The present invention relates to a process for the moderately refractory assembling of articles, parts, made of silicon carbide-based materials by non-reactive brazing, with a non-reactive brazing composition, in order especially to produce components based entirely on silicon carbide.

The invention also relates to brazing compositions, and to the moderately refractory assembly and joint obtained by this process.

The term “silicon carbide-based material” generally means a material whose SiC content is greater than or equal to 50% by mass, preferably greater than or equal to 80% by mass and more preferably 100% by mass: in the latter case, it may be said that the material is constituted or composed of silicon carbide.

Silicon carbide may be in the form of silicon carbide fibres or silicon carbide powder that is sintered or bound with a ceramic binder.

These silicon carbide-based materials may especially be pure silicon carbide such as pure α silicon carbide (α-SiC) or β silicon carbide (β-SiC), silicon-infiltrated silicon carbide substrates (SiSiC), or SiC-based composite materials such as composites with silicon carbide fibres and/or with a silicon carbide matrix.

The technical field of the invention may be defined as being that of brazing at “moderate temperature”, i.e. it uses temperatures not exceeding 1300° C. and preferably not exceeding 1250° C.

The assemblies concerned by the present invention are thus generally considered as “moderately refractory”, i.e. the maximum working temperature of these assemblies is generally up to 1000° C. or even 1100° C. and may be, for example, about 1000° C.

These assemblies may be included in the manufacture of components of complex shapes requiring both very good mechanical strength between the silicon carbide-based substrates and satisfactory sealing on either side of the joint.

### STATE OF THE PRIOR ART

It is known that it is difficult to manufacture large-sized ceramic articles, in particular made of SiC. The reason for this is that the tolerances after sintering of large-sized silicon carbide primary components are poorly mastered and the machining of these components is unacceptable for cost reasons.

Moreover, and for the same reasons, it is generally difficult to manufacture articles, parts, of complex shape with silicon-based compounds such as silicon carbide.

It is thus often preferable to manufacture articles or structures of large size and/or of complex shape from ceramic elements of simple shape and/or of small size, and then to assemble these elements to produce the final structure.

Such a technique is especially necessary for manufacturing structures such as heat exchangers, with structural components made of silicon carbide having a working temperature, for example, of up to 1000° C. or even 1100° C.

Due to the high temperatures, for example in the region of 1000° C., used in the applications of ceramics such as silicon carbide, assembly of these ceramics by bonding with organic adhesives is excluded, since the working temperatures of this type of assembly cannot exceed a maximum of 200° C.

Purely mechanical assembling, for example by stapling or screwing, affords an only partial and random contact between the articles. The assemblies thus obtained cannot be leaktight.

Moreover, standard assembling techniques by welding involving an energy beam with or without a supply of metal (TIG, electron-beam or laser-beam welding) and involving partial fusion of the parts to be assembled are unusable for the assembling of ceramics due to the fact that a ceramic substrate or article cannot be melted and that, in particular, silicon carbide decomposes before melting.

Common techniques for performing refractory assembling of ceramics are solid-state diffusion welding and sintering or cosintering assembly.

In assembly by diffusion welding, a pressure is applied at high temperature to the interfaces to allow atomic inter-diffusion between the two substrates. The temperature must always remain below the melting point of the least refractory material, and there is therefore no liquid phase in the system. This type of assembly is performed either in a press in a single direction, or in an isostatic chamber. Diffusion welding is particularly suited to assembly between two metal alloys and poorly suited to the assembling of ceramic materials since the atoms constituting the ceramic diffuse very sparingly in the region of the joint. In addition, the process is mechanically prohibitive, since it requires the compression of porous and fragile substrates and materials such as silicon carbide-based substrates, which risk being greatly damaged during this mechanical compression loading.

The sintering or cosintering assembly of SiC articles also requires high pressures, but also high temperatures and long stages, since this process is based on the principle of inter-diffusion between the SiC elements.

In other words, solid-state diffusion welding and sintering assembly have the drawback of being constraining from the point of view of their implementation, since:
for solid-state diffusion welding, the shape of the articles, parts, must remain simple if uniaxial pressing is used, or alternatively complex tooling and a complex preparation are necessary, comprising, for example, the manufacture of an envelope, leaktight vacuum closure, hot isostatic pressing, and final machining of the envelope, if HIP (Hot Isostatic Pressing) is used;
in the case of cosintering or sintering assembly, the same problems remain (shape of the articles, complexity of implementation) with, in addition, the need to control the sintering of an added powder to be intercalated between the two materials to be assembled;
these two techniques also require the use of long stages (one to several hours) at high temperature since the processes used involve solid-state diffusion.

It emerges from the foregoing, and in summary, that in order especially to ensure good mechanical strength and satisfactory leaktightness of the assembly, only processes using a liquid phase, such as brazing, may be envisaged.

Brazing is a relatively inexpensive technique that is easy to perform and that is the one most commonly used. Articles of complex shape may be made by brazing, and brazing operations are limited to placing between the articles to be assembled or close to the joint between the two articles, a brazing alloy, known as a braze, or an added alloy, this alloy being capable of wetting and of spreading over the interfaces to be assembled to fill the joint between the articles and to melt this alloy. After cooling, the braze solidifies and gives the assembly cohesion.

Most of the brazing compositions for articles made of silicon carbide-based materials are not sufficiently refractory, i.e. they may be described as being moderately refractory. They are generally brazing compositions consisting of metal alloys having a melting point that is lower, or even very much lower, than 1000° C. Such a melting point is largely insufficient for applications at temperatures in the region of 1000° C. or 1100° C.

Moreover, most of the chemical elements that form part of these metallic brazing compositions are highly reactive with silicon carbide at and above 500° C. and create fragile compounds.

Consequently, in the case of brazing performed above 1000° C., such brazing compositions or brazing alloys would chemically attack silicon carbide-based materials, not only during the brazing operations, but also during functioning by solid-state diffusion.

In addition, the least reactive alloys are also the least refractory, for instance the alloy AgCuTi with an Ag—Cu matrix and a Ti active element in low concentration. For the applications more particularly targeted by the invention, which are those of a moderately refractory assembly, with a working temperature of the assembling that may generally be up to 1000° C., all reactive brazing compositions consisting mainly of silver or silver-copper, copper, nickel, iron or cobalt, platinum, palladium or gold must therefore be excluded on account of their high reactivity with silicon carbide.

Brazing alloy formulations that are more refractory and rich in silicon are presented in documents [1, 2, 3]. These brazing compositions show very sparingly reactive, or even unreactive, behaviour with SiC, which avoids the formation of fragile compounds. However, this criterion of non-reactivity or of very low reactivity is not a sufficient condition for ensuring good mechanical strength of brazed joints. Specifically, in the literature, the breaking stress values are very variable as a function of the second element included in the silicon-based brazing composition. For example, for the Fe—Si non-reactive system (45% Fe-55% Si by mass), document [3] mentions an extremely low tensile breaking stress, of the order of 2 MPa, whereas for the Cr—Si system (25% Cr-75% Si by mass), this same document gives a high-value, of the order of 12 MPa.

The properties, especially the mechanical properties, of a silicon-based brazing composition are totally unpredictable and cannot in any way be deduced from the mechanical properties of already-known Si-based brazing compositions, even very similar ones.

In other words, when it is sought to prepare a silicon-based brazing composition, especially for brazing SiC-based articles, it is not at all possible to base one's reasoning on the possibly acceptable mechanical properties shown by other known Si-based brazing compositions, since any modification, even a very small one, of a Si-based brazing composition, both as regards the nature of the metal(s) brazed with the silicon, and as regards their proportions, may lead to very substantial, unexpected, unpredictable changes in the properties of the composition, and in particular in its mechanical properties.

In conclusion, no possibility exists of predicting the mechanics of a given Si—X system in which X is a metal, and even less so the mechanics of a system as a function of the proportions of X.

The brazing temperatures of the brazing compositions in documents [1, 2] and [3] are generally above 1300° C. These brazing temperatures are, for example, 1355° C. for the composition Ti—Si (22-78% by mass), 1355° C. for the composition Cr—Si (25-75% by mass), 1350° C. to 1450° C. for the composition Co—Si, and 1750° C. for the composition Ru₂Si₃.

Specifically, the efficacy of this assembly process requires brazing temperatures above 1300° C. in order to thermodynamically destabilize the passivating silicon oxide layers that appear spontaneously on the surfaces of silicon carbide, since these silicon oxide layers impair the wetting with the brazing composition, even if the brazing is performed under vacuum.

Consequently, the abovementioned silicon-rich brazing alloys used at a temperature above 1300° C. are unsuitable for brazing substrates made of silicon carbide-based material whose properties degrade after exposure to 1300° C. or above.

Document [3] does, admittedly, present a Ge—Si (10%-90%) brazing composition that may be brazed at 1220° C. However, the mechanical strength of this joint (tensile breaking stress between 300 and 400 p.s.i., i.e. between 2 and 2.75 MPa) is very poor and insufficient for numerous applications, despite the low reactivity of this braze with SiC.

Document [2] proposes a Pt—Si alloy that is brazed at 1200° C. The Pt content of this brazing composition is very high (77% by weight of Pt), which leads to a very expensive process. This drawback is prohibitive for producing large brazed articles, parts.

Finally, document [4] presents brazing alloys with a Si content of less than 50% by mass, preferably from 10% to 45% by mass, and with addition of at least two elements chosen from the following group: Li, Be, B, Na, Mg, P, Sc, Ti, V, Cr, Mn, Fe, Co, Zn, Ga, Ge, As, Rb, Y, Sb, Te, Cs, Pr, Nd, Ta, W and Tl.

The examples of document [4] describe Si—Cr—Co (11%-38.5%-50.5% by mass); Si—Cr—Co (40%-26%-34% by mass); Si—Fe—Cr (17.2%-17.5%-65.3% by mass); and Si—Fe—Co (20%-20%-60% by mass) ternary brazing compositions, and their brazing at temperatures of 1230° C., 1235° C., 1460° C. and 1500° C., respectively.

As regards the brazing compositions having brazing temperatures below 1300° C., it is simply mentioned that a “strong” bond is obtained, and no mechanical test is given to prove that good mechanical strength of the joints is actually obtained. Similarly, the low SiC/braze reactivity is neither mentioned nor suggested.

In the light of the foregoing, there is thus an as yet unsatisfied need for a process for performing the assembly by brazing of articles made of silicon carbide-based materials, which simultaneously affords leaktightness of the joint and also satisfactory mechanical strength of the assembly above 500° C., and which uses brazing temperatures below 1300° C.

Specifically, it is essential for the articles, parts, or substrates to keep all their integrity and initial performance qualities after the brazing assembly operation. There is thus a need for a brazing process using brazing compositions that make it possible to reach the desired working temperatures, i.e. up to 1000° C. or even 1100° C., while at the same time avoiding subjecting the articles or substrates made of silicon carbide-based materials to temperature ranges that might impair these materials.

In other words, there is a need for a brazing process that makes it possible to obtain moderately refractory brazed joints (with a use up to 1000° C. or even 1100° C.) using brazing cycles that do not exceed 1300° C. and preferably do not exceed 1250° C.

The reason for this is that above this temperature, many silicon-based materials, especially composites, are irreversibly impaired. This is especially the case for SiC/SiC composites with a self-healing matrix, in which glasses protect the SiC fibres during functioning in air at about 800° C., for example.

In other words, there is a need for a brazing process and a brazing composition or brazing alloy that make it possible firstly to use all the refractory potential of silicon carbide-based substrates, with working temperatures of up to about 1000° C. or even 1100° C., and secondly to braze at a brazing temperature below the temperature at which the substrates are impaired, with a melting point of the brazing alloy below 1300° C. or better still below 1250° C.

There is also a need for a process for performing the assembly, by moderately refractory brazing, of articles made of silicon carbide-based materials, irrespective of their shape and/or size.

There is in particular a need for a brazing process, and for the associated brazing composition, for performing the moderately refractory brazing of silicon carbide-based articles of large sizes and/or of complex geometries, especially having large surface areas to be brazed.

In addition, none of the processes or compositions of the prior art simultaneously satisfies the following criteria, demonstrated by the inventors, and which are fundamental for producing structure components made of SiC involving moderately refractory joints:

1) the brazing composition should make it possible to produce a strong bond between the two articles, parts, made of silicon carbide-based material, which implies a non-reactive brazing composition, i.e. a composition that is chemically compatible with silicon carbide, and which does not form fragile compounds therewith. However, the non-reactivity does not ensure the creation of a strong bond, since this remains unpredictable. Non-reactivity is a necessary but insufficient condition for having a strong bond. Thus, the Fe—Si system cited in the literature [3] is non-reactive but its mechanical strength is very poor.

2) the brazing composition should satisfactorily wet the silicon carbide and adhere well thereto.

3) the brazing composition should be compatible with all heating devices, especially rapid and/or localized heating devices.

4) the brazing composition should allow the formation of joints that show good mechanical strength.

5) the brazing composition should be formed from a limited number of elements, in order to facilitate its preparation and use.

6) the brazing composition should not contain expensive elements, such as precious, noble, metals.

Finally, the process and the associated braze should allow the brazing and assembly of any type of silicon carbide-based material and should be readily adaptable to any specific silicon carbide-based ceramic.

The aim of the invention is thus to provide a process for the assembly by brazing of articles or components made of silicon carbide-based materials, which meets, inter alia, the needs mentioned above, which satisfies, inter alia, all of the requirements and criteria mentioned above, which eliminates the drawbacks, faults and limitations encountered with the processes of the prior art, and which makes it possible to obtain good leaktightness of the joint and also satisfactory mechanical strength of the assembly above 500° C., and which uses brazing temperatures below 1300° C.

### DESCRIPTION OF THE INVENTION

This aim, and others, are achieved in accordance with the invention by a process for the assembly of at least two articles, parts, made of silicon carbide-based materials by moderately refractory non-reactive brazing, in which the articles, parts, are placed in contact with a non-reactive brazing composition, and the assembly formed by the articles, parts, and the brazing composition is heated to a brazing temperature that is sufficient to melt the brazing composition in order to form a moderately refractory joint, in which the non-reactive brazing composition is a binary alloy consisting of, composed of, as mass percentages, 56% to 70% silicon and 44% to 30% yttrium.

The term “moderately refractory brazing” means brazing generally performed at a temperature of between 1150° C. and 1300° C. and preferably between 1200° C. and 1300° C.

The term “moderately refractory joint” means that this joint is generally capable of withstanding operating temperatures ranging up to 1000° C. or even 1100° C., and generally in the region of 1000° C. or even 1100° C.

The process according to the invention, which is a process of moderately refractory brazing at a temperature of less than or equal to 1300° C., using a specific brazing composition, has never been described in the prior art.

In particular, the specific brazing composition used according to the invention which, surprisingly, allows moderately refractory brazing at a temperature of less than or equal to 1300° C. of articles made of silicon carbide-based materials is not in any way mentioned in the prior art documents cited hereinabove.

Thus, document [4] incidentally mentions yttrium among a list of 27 metals that can form a brazing composition with silicon. The silicon is always present in less than 50% by mass. None of the brazing compositions illustrated in the said document contains yttrium. The said document contains no indication that could lead to selecting yttrium, and a fortiori a specific content thereof, for preparing a braze that is compatible with SiC, ensuring brazing at 1300° C. or below 1300° C. of SiC-based articles, and effective assembling of these articles.

The process according to the invention meets the needs and satisfies all the requirements and criteria mentioned above, and does not have the drawbacks of the processes of the prior art.

In particular, the process according to the invention allows for the first time the preparation of moderately refractory assemblies, i.e. assemblies with an operating temperature that may be up to 1000° C. or even 1100° C., of articles made of silicon carbide-based materials irrespective of their geometry, even of very complex geometry, and/or of their size.

The process according to the invention especially ensures in all cases good leaktightness of the joint, good filling of the joint with the braze and also excellent mechanical strength of the assembly at room temperature and at elevated temperature, in particular above 500° C.

The process according to the invention is also simple, reliable, easy to implement and inexpensive overall.

In other words, the many surprising advantages and effects of the invention may be listed as follows, without this list being considered as limiting:
the assembly obtained according to the invention makes it possible to ensure very good mechanical attachment between the silicon carbide-based substrates, even for maximum working temperatures above 500° C., which may for example be up to 1000° C. or even 1100° C. depending on the composition of the brazing alloy. Breakages take place in “cohesive” mode, i.e. cracks occur in the silicon carbide-based substrates and not at the brazed joint;
the brazing temperature is less than or equal to 1300° C. and it is thus possible via the process according to the invention to assemble silicon carbide-based articles or substrates that cannot withstand temperatures above 1300° C., for instance articles or substrates made of composite with a ceramic matrix and ceramic fibres with a self-healing matrix;
surprisingly, despite the brazing temperature equal to 1300° C. or below 1300° C. used in the process of the invention, good wetting of the brazing composition or of the brazing alloy according to the invention on the surfaces of silicon carbide-based substrates or articles to be assembled, was observed. Thus, by virtue of this good wetting of the surfaces, it is possible according to the invention to perform capillary brazing since the brazing composition according to the invention can by itself fill the joint between the articles during the brazing operation;
the brazed joints obtained via the process according to the invention are leaktight. The process according to the invention is consequently suited to sealing operations that need to withstand maximum temperatures of between 850° C. and 1100° C. depending on the composition of the brazing alloy;
extremely moderate reactivity of the brazing alloy on the silicon carbide-based substrates has been observed. There are no complex and porous embrittling zones at the interface;
the brazing performed via the process according to the invention is reversible. It is thus possible to split or separate the assembled articles or substrates, for example in order to repair them, by melting the brazing alloy in an oven during a second operation of melting of this brazing alloy, without impairing the articles or substrates. The articles or substrates may also be separated by chemical attack;
another noteworthy property obtained via the process according to the invention is the uniformity of the joint obtained after brazing;
it is not necessary in the process according to the invention to metallize with the braze the articles, parts, or substrates made of SiC-based material before the brazing operation at a temperature below 1300° C.; the joints are satisfactorily filled with the brazing composition according to the invention, even in the capillary configuration;
the brazing compositions according to the invention do not contain any precious, noble, chemical element, especially metals of the platinum family, which limits their cost and the cost of the process using them, when compared with many compositions of the prior art.

As has already been mentioned previously, the behaviour of brazing compositions, more particularly for brazing SiC, is extremely unpredictable and cannot in any way be deduced from the behaviour of the known brazing compositions, even similar ones.

There was nothing to indicate that the use of the specific composition according to the invention in a process for brazing SiC-based articles could allow brazing at 1300° C. or below 1300° C. with all the beneficial effects and advantages listed hereinabove, especially as regards the leaktightness of the joint and the mechanical strength of the assembly above 500° C. without deterioration of the articles, parts.

The brazing composition used in the process of the invention is advantageously composed of (consists of), as mass percentages, 59% silicon and 41% yttrium.

Processes using the various brazing compositions defined by the advantageous percentages specified hereinabove are, a fortiori, neither described nor suggested in the prior art.

Advantageously, prior to brazing, a reinforce, strengthening agent may be added to the brazing composition.

This reinforcer may be made of a material chosen from SiC and C.

This reinforcer may be in the form of particles, for example a powder; fibres; a fibres nonwoven; or a fibres fabric.

The reinforcer may be added in an amount of from 5% to 49% by mass relative to the mass of the brazing composition.

Advantageously, in the process according to the invention, it is possible to form a powder of brazing composition, suspend this powder in an organic binder so as to obtain a suspension or paste, and coat at least one surface of the articles, parts, to be assembled with the suspension or paste obtained.

Thus, a surface to be assembled of at least one of the articles to be assembled may be coated with the suspension, slurry or paste, and the surfaces to be assembled of the articles may then be placed in contact so that the suspension or paste is intercalated between them, or alternatively the articles to be assembled may be placed in contact while maintaining an offset between them so as to create a surface capable of receiving the suspension or paste close to the joint formed by the surfaces to be assembled of the articles to be assembled, and the suspension or paste may then be applied to this surface.

Advantageously, prior to placing in contact with the brazing composition, carbon, for example carbon powder, may be applied to at least one of the surfaces to be assembled of the articles.

Advantageously, the brazing may be performed at a brazing temperature at least 30° C. above the melting point of the brazing composition.

Advantageously, the brazing may be performed by effecting a brazing stage at a brazing temperature of 1245° C. to 1280° C., maintained for a period of 20 to 90 minutes.

Preferably, the brazing stage may be effected at a brazing temperature of 1250° C. maintained for a period of 30 minutes.

Advantageously, prior to the brazing stage, a first stage may be effected at a temperature of 1120° C. to 1150° C. maintained for a period of 30 to 120 minutes and preferably from 60 to 90 minutes.

Advantageously, the silicon carbide-based materials may be chosen from pure silicon carbides such as pure α silicon carbide (α-SiC) or β silicon carbide (β-sic) and SiC-based composite materials such as composites with silicon carbide fibres and/or with a silicon carbide matrix.

More particularly, the silicon carbide-based materials may be chosen from pressureless sintered silicon carbide (PLS-SiC); Si-infiltrated silicon carbide (SiSiC or RBSC); porous recrystallized silicon carbide (RSiC); silicon graphite (C—SiC) formed of graphite and covered with a layer of SiC; SiC/SiC composites, for example containing fibres or “whiskers”; SiC/SiC composites with a self-healing matrix; C/SiC composites, for example, containing carbon fibres or “whiskers” and an SiC matrix; SiC monocrystals; SiC composites with another ceramic, for example SiC/Si₃N₄ and SiC/TiN composites.

Generally, the said silicon carbide-based materials have a silicon carbide content at least equal to 50% by mass, preferably at least equal to 80% by mass and more preferably equal to 100% by mass.

The invention further concerns, as novel brazing composition, a brazing composition composed of (consisting of) as mass percentages, 59% silicium and 41% yttrium.

The invention also relates to a brazing slurry, suspension or paste comprising a powder of one of the brazing compositions that have been described earlier in the context of the description of the process according to the invention, an organic binder, and optionally an addition of a reinforcer as defined above.

The invention also relates to a composition for the non-reactive moderately refractory brazing of articles made of silicon carbide-based materials comprising a non-reactive brazing composition as defined above in the context of the description of the process according to the invention, and also an addition of a reinforcer as defined above.

The invention also relates to the moderately refractory joint, and to the assembly comprising at least two articles made of SiC-based materials, obtained via the process according to the invention described above.

Other characteristics and advantages of the invention will emerge more clearly on reading the description that follows, given as non-limiting illustration in relation with the attached drawings, in which:

### BRIEF DESCRIPTION OF THE DRAWINGS

FIG. 1 is a schematic view showing the arrangement of the plates of SiC-based material and of the brazing composition paste for brazing in capillary configuration;

FIG. 2 is a schematic view of the specimens used for the mechanical tests, especially in shear, of the joints and assemblies prepared in the examples.

### DETAILED DESCRIPTION OF PARTICULAR EMBODIMENTS

The first step of the process according to the invention consists, firstly, generally, in preparing or producing a brazing composition, in other words a brazing alloy containing silicon and yttrium.

The brazing alloy according to the invention is an yttrium (Y)-silicon (Si) binary alloy.

The melting point of the brazing alloy according to the invention is less than or equal to 1300° C. The predominant element of the alloy is silicon.

The mass proportions for the Si—Y binary alloy are 56% to 70% silicon and 44% to 30% yttrium. The preferred brazing composition for this binary alloy is 59% by mass of Si and 41% by mass of Y.

The brazing composition is generally a pulverulent composition, which may be prepared, for example, by first synthesizing an intermetallic compound containing silicon and yttrium from the pure elements.

The synthesis of such an intermetallic composition is performed, for example, by introducing the silicon—for example in the form of pieces—the yttrium—for example in the form of wire, pieces or the like—into a refractory alumina crucible, for example, by heating, for example to a temperature of 1250° C. to 1400° C., to make the various constituents of the said composition melt and to obtain the final desired homogeneous intermetallic compound. The intermetallic compound obtained is then ground in any suitable apparatus, for example in a mortar, to obtain a powder of suitable particle size, i.e. the grains have, for example, a diameter of 1 to 250 μm.

Instead of being synthesized, the said intermetallic compound may also be a commercial compound that is in the form of a powder of intermetallic compound of known particle size and purity. Among these commercial powders, mention may be made, for example, of: the powder of the compound YSi₂ of the brand Cerac®, with a purity of 99.5% and a particle size of 50 to 100 μm.

However, in order to adjust the Si content of the brazing composition, it may be necessary to mix one of the powders of intermetallic compound mentioned above and especially YSi₂ with pure silicon powder. This pure silicon powder may be prepared from pieces of pure silicon ground in any suitable apparatus, for example in a mortar, to obtain a powder of suitable particle size whose grains have, for example, a diameter of 1 to 250 μm.

Instead of being thus prepared, the said pure silicon powder may also be a commercial powder of known particle size and purity. Among these commercial powders, mention may be made, for example, of: the pure Si powder, of Cerac® brand, with a purity of 99.5% or 99.99% and a particle size of about 50 μm.

The powder composed of the mixture of the powders of intermetallic compound and of Si constitutes, in this case, the brazing composition.

Thus, preferably, the binary brazing composition according to the invention will be prepared by weighing out powders of the Si and YSi₂ compounds in the proportions selected according to the invention and then mixing these powders in a “Turbula” for at least 30 minutes.

According to the invention, a reinforcer, strengthening agent, may also be added to the brazing composition prior to brazing, in order especially to improve the mechanical strength of the assembly.

This reinforcer may be a C or SiC reinforcer.

This reinforcer may be in the form of particles, for example of a powder such as a powder of SiC; of fibres, for example SiC or ceramic fibres; of a nonwoven in which fibres are isolated; of a fibre fabric.

The added reinforcer such as a SiC powder generally represents from 5% to 49% by weight of the brazing composition. The SiC powder may be, for example, a commercial powder, such as the powder of the brand name Starck®, with a purity of 98.5% and a particle size of less than 10 μm.

The powder of brazing composition (Si and Y), optionally supplemented with the reinforcer such as a SiC powder, is conventionally suspended in a binder, liquid organic cement, which is preferably both viscous and tacky so as to obtain a paste, slurry, or suspension of brazing composition optionally supplemented with a reinforcer that allows uniform spreading onto the surfaces of the silicon carbide-based articles or substrates to be brazed.

The binder or cement generally decomposes, for example, between 100 and 300° C. without leaving traces. It may be, for example, a cement of Nicrobraz® type.

The second step of the process according to the invention generally consists in performing the actual brazing assembly.

Prior to assembling, the two (or more) surfaces of the articles made of SiC-based materials to be assembled are generally degreased or cleaned in an organic solvent, for instance a ketone, an ester, an ether, an alcohol or a mixture thereof, etc., a preferred solvent being acetone or an acetone-ethyl alcohol-ether mixture, for example in ⅓, ⅓, ⅓ proportions; the articles may also be successively cleaned with several different solvents, for example with acetone and then with ethanol. The articles, parts, are then dried.

There are generally two articles made of SiC-based materials to be assembled, but a larger number of articles, which may be up to 100, may also be simultaneously assembled.

The expression “article, part, made of SiC-based materials” generally means any element or species of any size or shape included, for example after assembly with one or more other articles, in structures of larger size.

According to the invention, it is possible to assemble, with excellent results each time, articles of complex geometry or shape and/or of large size, for example with 0.5 m² or more of surface area to be brazed.

The term “silicon carbide-based material” generally means herein any material comprising at least 50% by mass of silicon carbide, preferably at least 80% by mass of silicon carbide and more preferably 100% by mass of silicon carbide; in the latter case, the material is composed solely (consists) of silicon carbide.

The silicon carbide-based materials may be chosen from pure silicon carbides such as pure α silicon carbide (α-SiC) or β silicon carbide (β-SiC) and SiC-based composite materials such as composites with silicon carbide fibres and/or with a silicon carbide matrix.

As examples of SiC-based materials, mention may be made of pure dense silicon carbide or pressure-less sintered silicon carbide (PLS-SiC); Si-infiltrated silicon carbide (known as SiSiC or RBSC containing 5% to 20% Si); porous recrystallized silicon carbide (known as RSiC); silicon graphite (C—SiC) composed of graphite and covered with a layer of SiC having a thickness, for example, of 0.1 to 1 mm; and also SiC/SiC composites, for example containing fibres or “whiskers”; SiC/SiC composites with a self-healing matrix; C/SiC composites, for example, containing carbon fibres or “whiskers” and an SiC matrix; and also SiC monocrystals; and SiC composites with another ceramic, for example SiC/Si₃N₄ and SiC/TiN. It has been found, surprisingly, that the process of the invention allows the composites to be brazed with excellent results.

The two or more articles to be assembled may be made of the same material, based on silicon carbide, for example made of PLS (pressureless sintered) α-SiC, or made of SiC—SiC composite, or each of the articles may be made of a different material.

The suspension, slurry, or paste of the brazing composition described previously is spread, coated or applied, for example with a coarse or fine brush, preferably uniformly, onto the surface of at least one of the articles, parts, made of silicon carbide-based material to be assembled, and the paste-coated surface(s) of the two articles to be assembled is (are) then placed in contact. This brazing configuration is known as the “sandwich configuration” since the paste of the brazing composition is placed directly between the surfaces of the articles, parts, to be assembled.

The amount of paste, slurry, or suspension of brazing composition to be used in this configuration is generally from 10 mg/cm² to 30 mg/cm², for example 20 mg/cm².

The sandwich configuration applies both for “thin” joins, i.e. with a thickness of less than 200 micrometres, and for thick joints, i.e. with a thickness of greater than or equal to 200 micrometres.

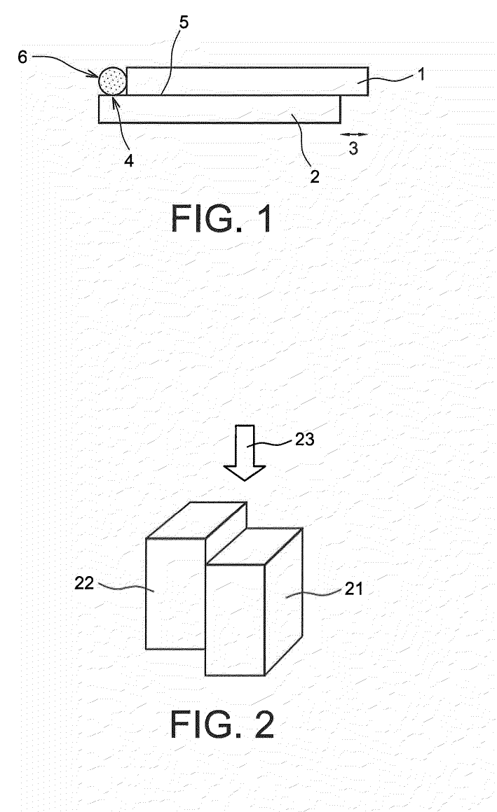

Alternatively, as shown in FIG. 1, the articles to be assembled, for example in the form of plates (1, 2), are placed in contact, without having applied any brazing composition between them, while maintaining a gap or offset (3) between them, generally of a few mm, for example 1 mm, 2 mm to 10 mm, so as to create a surface (4) capable of receiving the suspension, slurry, or paste close to the joint (5) formed by the surfaces to be assembled of the articles to be assembled, and the suspension, slurry, or paste of brazing composition is then applied, for example in the form of a bead, strip, of braze (6) on this surface close to the joint, at the edge of the joint.

This brazing configuration is known as the “capillary configuration”. With the brazing compositions according to the invention, it is possible to perform such capillary brazing, with infiltration of the liquid braze into the brazing joint during the brazing cycle, without directly placing the brazing composition between the articles to be assembled as in the case of the sandwich configuration. The capillary brazing is possible for “thin” joints with a thickness of less than 200 micrometres.

The amount of paste, slurry, or suspension of brazing composition to be used in this capillary configuration is generally from 10 mg/cm² to 30 mg/cm², for example 20 mg/cm².

In order to significantly accelerate the kinetics of wetting of the SiC-based materials with the brazing composition or the brazing alloy according to the invention, and to further reduce the wetting angle, it is possible to deposit carbon, for example carbon powder, onto at least one of the surfaces to be assembled of the substrates or articles made of SiC-based material, before applying the brazing composition paste.

The deposition of carbon may be performed, for example, by coating at least one of the surfaces to be assembled of the substrates or articles made of silicon carbide-based material with a paste containing an organic cement mixed with carbon powder.

The deposition of carbon may be performed by pencilling or rubbing the surface of at least one of the articles to be assembled with a graphite lead, or alternatively by chemical vapour deposition (CVD) or physical vapour deposition (PVD).

The articles ready to be brazed are then placed in a heating device such as an oven or subjected to heating by any other suitable means.

The oven is generally under vacuum or under an atmosphere of a neutral gas.

Generally, the vacuum is a secondary vacuum, i.e. the pressure is from 10⁻³ to 10⁻⁵ Pa, for example 10⁻⁴ Pa.

Preferably, the neutral gas is argon.

The invention even makes it possible to use argon of commercial grade (generally containing 5 ppm of O₂).

The articles to be assembled are subjected, for example in the oven, to a heating cycle.

Thus, the assembly formed by the articles and the brazing composition may be brought to the brazing temperature by applying a temperature rise that is preferably “slow”, with one or more temperature ramps from room temperature.

This temperature rise may take place, for example, with a temperature ramp at a rate of 1° C. to 5° C./minute.

The brazing stage is generally effected at a temperature, which is the brazing temperature, that is preferably at least 30° C. higher than the melting point or liquidus temperature of the brazing composition. The brazing temperature is moreover less than or equal to 1300° C.

Depending on the compositions, this liquidus temperature ranges from 1215° C. to 1260° C. The brazing temperature will thus vary, for example, from 1245° C. to 1280° C., and is preferably 1250° C.

Such a melting point of the compositions allows, according to another advantage of the process of the invention, use of the assembly up to 1000° C. and even up to 1100° C.

This brazing temperature is maintained for a period of 20 to 60 minutes, for example 30 minutes, which is known as the brazing stage.

A preferred brazing stage is performed at a brazing temperature of 1250° C. for 30 minutes.

Surprisingly, although the brazing temperature is below 1300° C., it allows both good attachment to and good wetting of the brazing composition on the surfaces of substrates made of silicon carbide-based materials. Specifically, the applied-drop tests (“essais de goutte posée” in French) show that it is possible to achieve contact angles of less than 60° and of the order of 50°. More specifically, the stationary wetting angle obtained with the brazing composition according to the invention on SiC is about 50° at 1250° C. After a 5-minute stage at 1250° C., the angle is still high, between 70° and 80°. The stationary angle, of about 50°, is reached after a stage of 30 minutes at 1250° C.

The satisfactory wetting obtained with the brazing compositions according to the invention is essential for the quality of filling of the joints formed, but is not always sufficient to ensure good mechanical behaviour.

The wetting kinetics may be further accelerated by applying a first stage at a temperature generally from 1120° C. to 1150° C. and for a period of 60 to 90 minutes before performing the actual brazing stage under the conditions already mentioned above, for example at a temperature of 1245° C. to 1280° C. By thus applying this first stage prior to the actual brazing stage, the stationary wetting angle, of about 50°, is obtained after 10 minutes of the brazing stage.

The duration of these stages may be increased, and may be lengthened, for example, to 120 minutes for the first stage and to 60 minutes for the second stage for articles of very large dimensions, for example with 0.5 m² or more of surface area to be brazed.

Acceleration of the wetting kinetics may also be obtained by deleting this first stage and by performing slow heating at a temperature of 1245° C. to 1280° C. so that the duration of exposure of the assembly in this temperature range is from about 60 to 90 minutes.

As has already been indicated hereinabove, the application of carbon to the surfaces to be assembled improves the wetting kinetics. If carbon is deposited and two stages are applied, a contact angle of about 40° is obtained after 10 minutes of a stage at 1250° C. The stationary angle, after 15 minutes, is slightly less than 40°.

After heating of the assembly formed by the articles, parts, and the brazing composition to a brazing temperature that is sufficient to melt the brazing composition, the articles, parts, and the brazing composition are cooled, whereby after solidification of said brazing composition a moderately refractory joint is obtained.

More precisely, at the end of the brazing cycle, after the brazing stage, the assembly is cooled to room temperature, for example at a rate of 5° C. or 6° C. per minute.

During cooling, the braze solidifies and the assembling of the articles made of silicon carbide-based material is effective both in the case where a sandwich configuration is used and in the case where a capillary configuration is used.

The assemblies produced via the process according to the invention were tested in pure shear at room temperature. The mean breaking stress obtained is about 30 MPa.

The assemblies of articles made of silicon carbide comprising joints prepared by the process according to the invention make it possible to produce structures, apparatus or components of complex shapes having high working temperatures that may be up to 1000° C. or even 1100° C., with great precision.

Specifically, it is known that the mechanical properties of silicon carbide:
great hardness;
low coefficient of expansion;
high breaking strength;
good thermal shock strength;
   and also its very good conductivity make it an indispensable material for the present and future industrial applications at high temperature.

Furthermore, SiC shows very good chemical resistance to various acids, including hydrofluoric acid, and very good resistance to oxidation in air at high temperature up to 1300° C.

In other words, the process according to the invention may be applied especially to the manufacture of any device, apparatus, structure or component requiring moderately refractory assembly between at least two silicon carbide-based substrates or articles while ensuring both good mechanical strength and satisfactory leaktightness of the assembly.

This type of device, apparatus, structure or component may satisfy needs in various fields:
the field of heat engineering, especially for designing highly efficient heat exchangers, since silicon carbide has good heat conductivity and good resistance to high temperatures in extreme environments;
the field of mechanical engineering for producing in embarked devices light, rigid, refractory components that are resistant to abrasion and resistant to mechanical stresses;
the field of chemical engineering, since silicon carbide is resistant to numerous corrosive chemical products, for instance strong acids and bases;
the field of nuclear engineering, for the production of sheathing for fuel rods;
the fields of spatial optics (telescope mirror made of SiC) and of aeronautics (article made of SiC/SiC composite);
power electronics using SiC.

The invention will now be described by means of the examples that follow, which, needless to say, are given as non-limiting illustrations.

### EXAMPLE 1

This example describes applied-drop tests performed with a brazing alloy or brazing composition according to the invention having the composition: 59% by mass of Si and 41% by mass of Y on sintered pure α-SiC, by applying a single brazing stage at 1255° C. and at 1270° C.

a) Preparation of the Brazing Composition and of the Brazing Paste

The braze having the targeted composition: 59% by mass of Si and 41% by mass of Y, was prepared from Si powder and from YSi₂ powder.

These powders were weighed out according to the proportions of the brazing composition. They were then mixed together in a Turbula for at least 30 minutes to obtain a homogeneous powder mixture.

An organic binder (Nicrobraz® cement) was added to this powder mixture in order to form a viscous paste.

b) “Applied Drop” Test at 1255° C.

The brazing paste thus prepared is used to form a small lump of braze with a mass of about 50 mg. This lump of braze is placed on a precleaned SiC plate.

The lump of braze and the plate are together placed in a brazing oven and subjected to a brazing heating cycle under a secondary vacuum with a single stage, which is the brazing stage, at 1255° C.

The lump of braze melts during this heat treatment and forms a drop known as an “applied drop”.

The wetting angle of the drop is measured in situ for various brazing stage durations.

After a stage of 10 minutes, the contact angle is about 70°. The stationary angle is obtained after a stage of 30 minutes, and is about 50°.

After solidification, the SiC and its drop of solidified braze were cut out, coated and polished, and were observed by scanning electron microscopy.

The SiC/braze interface does not show any reactivity at the scanning electron microscopy scale, i.e. there is no formation of new compound. In particular, there is no formation of fragile compounds at the interface.

c) “Applied Drop” Test at 1270° C.

A test was performed under the same conditions as those described in paragraph b) above, but with a brazing stage of 1270° C.

This test led to the same results as those mentioned in paragraph b).

### EXAMPLE 2

This example describes applied-drop tests performed with a brazing composition or brazing alloy according to the invention having the composition: 59% by mass of Si and 41% by mass of Y on sintered pure α-SiC, by applying a brazing stage at 1270° C., preceded by a stage at 1135° C.

a) Preparation of the Brazing Composition and of the Brazing Paste

The brazing composition and the brazing paste were prepared as described in Example 1.

b) Applied-Drop Test

The brazing paste thus prepared is used to form a small lump of braze with a mass of about 50 mg. This lump of braze is placed on a precleaned SiC plate.

The lump of braze and the plate are together placed in a brazing oven and subjected to a brazing heating cycle under a secondary vacuum, which comprises two stages:
a first stage of 90 minutes at 1135° C.;
a second stage, which is the brazing stage, at 1270° C.

The lump of braze melts during this heat treatment and forms an “applied drop”.

The wetting angle of the drop is measured in situ for various brazing stage durations.

After a stage of 10 minutes, the contact angle is about 50°. The stationary angle is obtained after a stage of 30 minutes, and is slightly less than 50°.

### EXAMPLE 3

This example describes applied-drop tests performed with a brazing composition or brazing alloy according to the invention having the composition: 59% by mass of Si and 41% by mass of Y on carbon-bearing sintered pure α-SiC, by applying a brazing stage at 1270° C., preceded by a stage at 1135° C.

The deposition of carbon may be performed by chemical or physical vapour deposition—CVD or PVD—or by rubbing with a graphite lead. The carbon content is between 0.1 mg/cm² and 1 mg/cm². For this sample, a graphite lead was used.

a) Preparation of the Brazing Composition and of the Brazing Paste

The brazing composition and the brazing paste were prepared as described in Example 1.

b) Applied-Drop Test

The brazing paste thus prepared is used to form a small lump of braze with a mass of about 50 mg. This lump of braze is placed on a precleaned SiC plate.

The lump of braze and the plate are together placed in a brazing oven and subjected to a brazing heating cycle under a secondary vacuum, which comprises two stages identical to those described in Example 2:

a first stage of 90 minutes at 1135° C.;

a second stage, which is the brazing stage, at 1270° C.

The lump of braze melts during this heat treatment and forms an “applied drop”.

The wetting angle of the drop is measured in situ for various brazing stage durations.

After a stage of 10 minutes, the contact angle is about 40°. The stationary angle is obtained after a stage of 15 minutes, and is slightly less than 40°.

After solidification, the SiC and its drop of solidified braze were cut out, coated and polished, and were observed by scanning electron microscopy.

The SiC/braze interface does not show any reactivity at the scanning electron microscopy scale.

### EXAMPLE 4

This example describes the preparation of bonds or assemblies between two articles made of sintered pure α-SiC silicon carbide, using the brazing process according to the invention, the brazing being performed in capillary configuration using a brazing composition according to the invention composed of 59% by mass of Si and 41% by mass of Y.

This example also describes mechanical tests performed on these assemblies.

a) Preparation of the Brazing Composition, of the Brazing Paste and of the Articles, Parts, to be Assembled

The braze having the targeted composition, i.e. 59% by mass of Si and 41% by mass of Y, was prepared from Si powder and YSi₂ powder.

These powders were weighed out according to the proportions of the brazing composition. They were then mixed together in a Turbula for at least 30 minutes. to obtain a homogeneous powder mixture.

An organic binder (Nicrobraz® cement) was added to this powder mixture in order to form a viscous paste.

The sintered SiC articles to be assembled are plates 20×20 mm² in size and 1 mm thick.

The articles are cleaned with acetone and then with ethanol and finally dried.

The substrates or articles are placed in contact leaving an offset of 1 to 2 mm, so as to leave a space for applying the brazing paste close to the joint (this configuration is known as the capillary configuration). The paste is applied by spatula to the available surface at the edge of the joint, in the form of a bead, strip, of braze (see FIG. 1). The amount applied is between 50 and 100 mg for this assembly.

b) Brazing

The articles placed in contact and ready to be brazed are placed in a brazing oven under a secondary vacuum and subjected to a brazing heating cycle under vacuum, which comprises two stages identical to those described in Example 2:
a first stage of 90 minutes at 1135° C.;
a second stage, which is the brazing stage, at 1270° C.

c) Observation of the Joint

After cooling, the assembly is satisfactorily assembled. The joint was characterized by scanning electron microscopy. There is no “shortage” and no reactivity is revealed at the scanning electron microscopy scale.

d) Preparation of the Mechanical Test Specimens and Results of the Mechanical Tests

Mechanical test specimens (4 specimens) were prepared by brazing two articles 20×10×1 mm³ in size (21, 22) with the brazing paste prepared in a) above and under the brazing conditions described in b) above. Specifically, since the mechanics of ceramics are statistical, more than one specimen is prepared for the tests, but with the same manufacturing process.

The specimens are represented schematically in FIG. 2. They are fixed in a mounting and subjected to shear (23) at room temperature.

Results of the Mechanical Tests:

The breaking stresses determined for each of the four specimens are 27 MPa; 21 MPa; 21 MPa; 34 MPa; i.e. an average of 25 MPa.

### EXAMPLE 5

This example describes the preparation of bonds or assemblies between two articles made of carbon-bearing (“carbonized”) sintered pure α-SiC silicon carbide, using the brazing process according to the invention, the brazing being performed in capillary configuration using a brazing composition according to the invention composed of 59% by mass of Si and 41% by mass of Y.

This example also describes mechanical tests performed on these assemblies.

a) Preparation of the Brazing Composition, of the Brazing Paste and of the Articles to be Assembled

The brazing composition and the brazing paste are prepared as described in Example 4.

The sintered SiC articles to be assembled are plates 20×20 mm² in size and 1 mm thick.

The articles are cleaned with acetone and then with ethanol and finally dried.

The articles are carbonized by pencilling using a graphite lead.

The substrates or articles are placed in contact leaving an offset of 1 to 2 mm, so as to leave a space for applying the brazing paste close to the joint (this configuration is known as the capillary configuration). The paste is applied by spatula to the available surface at the edge of the joint, in the form of a bead of braze as in Example 4 (see FIG. 1). The amount applied is between 50 and 100 mg for this assembly.

b) Brazing

The articles placed in contact and ready to be brazed are placed in a brazing oven under a secondary vacuum and subjected to a brazing heating cycle under vacuum identical to that of Example 4, which comprises two stages identical to those described in Example 2:
a first stage of 90 minutes at 1135° C.;
a second stage, which is the brazing stage, at 1270° C.

c) Observation of the Joint

After cooling, the assembly is satisfactorily assembled. The joint was characterized by scanning electron microscopy. There is no “shortage” and no reactivity is revealed at the scanning electron microscopy scale.

d) Preparation of the Mechanical Test Specimens and Results of the Mechanical Tests

Mechanical test specimens (4 specimens) were prepared by brazing two articles 20×10×1 mm³ in size (21, 22) with the brazing paste prepared in a) above and under the brazing conditions described in b) above.

The specimens are represented schematically in FIG. 2. They are fixed in a mounting and subjected to shear (23) at room temperature.

Results of the Mechanical Tests:

The breaking stresses determined for each of the four specimens are 16 MPa; 49 MPa; 37 MPa; 35 MPa; i.e. an average of 34 MPa.

### EXAMPLE 6

This example is a comparative example that describes applied-drop tests performed with a comparative brazing composition or brazing alloy, not in accordance with the invention, having the composition: 6% by mass of Si and 94% by mass of Y on sintered pure α-SiC.

a) Preparation of the Brazing Composition and of the Brazing Paste

The braze having the targeted composition: 6% by mass of Si and 94% by mass of Y, was prepared from YSi₂ powder and small pieces of Y. This is a composition that lies in another low-temperature region of the Y—Si phase diagram.

These powders were weighed out according to the proportions of the brazing composition. They were then mixed together in a Turbula for at least 30 minutes to obtain a homogeneous powder mixture.

An organic binder (Nicrobraz® cement) was added to this powder mixture in order to form a viscous paste.

b) “Applied Drop” Test

The brazing paste thus prepared is used to form a small lump of braze with a mass of about 50 mg. This lump of braze is placed on a precleaned SiC plate.

The lump of braze and the plate are together placed in a brazing oven and subjected to a brazing heating cycle under a secondary vacuum.

The heating was programmed up to 1520° C. so as to observe the melting of the lump of braze (which in principle should melt during this heat treatment and form an “applied drop”) and its spreading on the SiC.

No outright melting was observed up to 1520° C.

The lump of braze barely melted, even above the theoretical melting point of this alloy (the theoretical starting melting point of this alloy is 1260° C., and total fusion should theoretically be at about 1400° C. according to the Y—Si phase diagram), it only became deformed.

This situation does not make it possible to envisage the brazing of a SiC-based material with this brazing composition at a temperature below 1300° C. and even up to 1520° C., since only very partial melting took place even at this high temperature of 1520° C.

This comparative example demonstrates that the use of the Y—Si binary phase diagram is insufficient to predict the behaviour of the braze with respect to silicon carbide.

Surprisingly, only the very specific contents of Si and of Y of the brazing compositions according to the invention ensure effective assembling of two SiC-based substrates, whereas nothing could have predicted this.

### REFERENCES

[1] Gasse A., Coing-Boyat G., Bourgeois G., “Method using a thick joint for joining parts in SiC-based materials by refractory brazing and refractory thick joint thus obtained”, U.S. Pat. No. 5,975,407, 1999.
[2] Gasse A., “Method for assembling parts made of materials based on SiC by non-reactive refractory brazing, brazing composition, and joint and assembly obtained by said method”, patent application US-A1-2003/0 038 166.
[3] Heap H., “Method for assembling parts made of materials based on SiC by non-reactive refractory brazing, brazing composition, and joint and assembly obtained by said method”, patent US-A-2003/0 038 166, 1974.
[4] Montgomery F. C., Streckert H. H., Braze for Silicon Carbide bodies, U.S. Pat. No. 5,447,683, 1995

1. A process for the assembly of at least two articles made of silicon carbide-based materials by moderately refractory non-reactive brazing, the process comprising:
placing said at least two articles in contact with a non-reactive brazing composition; and
heating the assembly formed by the articles and the brazing composition to a brazing temperature that is sufficient to melt the brazing composition in order to form a moderately refractory joint,
wherein the non-reactive brazing composition is a binary alloy composed, as mass percentages, of 56% to 70% silicon and 44% to 30% yttrium.

2. The process according to claim 1, in which the said brazing composition is a binary alloy composed, as mass percentages, of 59% silicon and 41% yttrium.

3. The process according to claim 1, in which, prior to brazing, a reinforcer is added to the brazing composition.

4. The process according to claim 3, in which the reinforcer is made of a material chosen from SiC and C.

5. The process according to 4 claim 3, in which the reinforcer is in the form of particles consisting of one of a powder, fibres nonwoven or fibres fabric.

6. The process according to claim 3, in which the said addition of a reinforcer is performed in an amount of from 5% to 49% by mass relative to the mass of the brazing composition.

7. The process according to claim 1, further comprising:
forming a brazing composition powder suspended in an organic binder so as to obtain a suspension, slurry, or paste, and
coating at least one surface of the at least two articles to be assembled with the suspension, slurry, or paste obtained.

8. The process according to claim 7, further comprising:
coating a surface to be assembled of at least one of the articles to be assembled with the suspension, slurry, or paste, and
placing in contact the surfaces to be assembled of the articles so that the suspension, slurry, or paste is intercalated between them.

9. The process according to claim 7, in which the articles to be assembled are placed in contact while maintaining an offset between them so as to create a surface capable of receiving the suspension, slurry, or paste close to the joint formed by the surfaces to be assembled of the articles to be assembled, and the suspension, slurry, or paste is then applied to this surface.

10. The process according to claim 1, in which, prior to placing in contact with the brazing composition, carbon or carbon powder is deposited onto at least one of the surfaces to be assembled of the at least two articles.

11. The process according to claim 1, in which the brazing is performed at a brazing temperature at least 30° C. above the melting point of the brazing composition.

12. The process according to claim 11, in which the brazing is performed by effecting a brazing stage at a brazing temperature of 1245° C. to 1280° C., maintained for a period of 20 to 90 minutes.

13. The process according to claim 12, in which the brazing stage is effected at a brazing temperature of 1250° C. maintained for a duration of 30 minutes.

14. The process according to claim 12, in which, prior to the brazing stage, a first stage is effected at a temperature of 1120° C. to 1150° C. maintained for a duration of 30 to 120 minutes.

15. The process according to claim 1, in which the silicon carbide-based materials are chosen from pure silicon carbides pure α silicon carbide (α-SiC) or β silicon carbide (β-SiC), and SiC-based composite materials with silicon carbide fibres and/or with a silicon carbide matrix.

16. The process according to claim 1, in which the silicon carbide-based materials are chosen from pressureless sintered silicon carbide (PLS-SiC); Si-infiltrated silicon carbide (SiSiC or RBSC); porous recrystallized silicon carbide (RSiC); silicon graphite (C—SiC) composed of graphite and covered with a layer of SiC; SiC/SiC composites containing fibres or “whiskers”; SiC/SiC composites with a self-healing matrix; C/SiC composites containing carbon fibres or “whiskers” and an SiC matrix; SiC monocrystals; SiC composites with another ceramic SiC/Si3N4; and SiC/TiN composites.

17. The process according to claim 1, in which said silicon carbide-based materials have a silicon carbide content at least equal to 50% by mass, preferably at least equal to 80% by mass and more preferably equal to 100% by mass.

18. A brazing composition composed, as mass percentages, of 59% silicon and 41% yttrium.

19. A composition for the non-reactive moderately refractory brazing of articles made of silicon carbide-based materials, comprising:
a non-reactive brazing composition binary alloy composed, as mass percentages, of 56% to 70% silicon and 44% to 30% yttrium; and
an added reinforcer.

20. A brazing suspension, slurry, or paste comprising a powder of a brazing composition binary alloy composed, as mass percentages, of 56% to 70% silicon and 44% to 30% yttrium; an organic binder, and
an added reinforcer.

21. A moderately refractory joint obtained via the process according to claim 1.

22. An assembly comprising at least two articles made of SiC-based materials, obtained via the process according to claim 1.

23. The process according to claim 14, in which, prior to the brazing stage, a first stage is effected at a temperature of 1120° C. to 1150° C. maintained for a duration of from 60 to 90 minutes.

24. The process according to claim 17, in which said silicon carbide-based materials have a silicon carbide content at least equal to 80% by mass.

25. The process according to claim 17, in which said silicon carbide-based materials have a silicon carbide content equal to 100% by mass.
